(19) United States
(12) Patent Application Publication
(10) Pub. No.: US 2021/0273268 A1
(43) Pub. Date: Sep. 2, 2021

(54) ELECTROCHEMICALLY ACTIVE INTERLAYERS FOR RECHARGEABLE BATTERIES

(71) Applicant: NANYANG TECHNOLOGICAL UNIVERSITY, Singapore (SG)

(72) Inventors: Linghui YU, Singapore (SG); Zhichuan XU, Singapore (SG); Luyuan Paul WANG, Singapore (SG)

(21) Appl. No.: 17/258,648

(22) PCT Filed: Jul. 12, 2019
(86) PCT No.: PCT/SG2019/050341

§ 371 Date: Jan. 7, 2021

(30) Foreign Application Priority Data
Jul. 13, 2018 (SG) 10201806028W

(51) Int. Cl. H01M 10/42; H01M 10/0525; H01M 4/36; H01M 10/44; H01M 50/417; H01M 50/497

(52) U.S. Cl. CPC H01M 10/4235; H01M 10/0525; H01M 50/497; H01M 10/44; H01M 50/417; H01M 4/366

(57) ABSTRACT

A rechargeable battery is provided. The rechargeable battery includes an anode, a cathode, an electrolyte in contact with the anode and the cathode, and an interlayer disposed between the anode and the cathode in the electrolyte. The anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode. An interlayer disposable between the anode and the cathode in the electrolyte of a rechargeable battery is also provided. The interlayer inhibits growth of the one or more dendrites in a direction from the interlayer to the cathode.

### CROSS-REFERENCE TO RELATED APPLICATION

This application claims the benefit of priority of Singapore Patent Application No. 10201806028W, filed 13 Jul. 2018, the content of it being hereby incorporated by reference in its entirety for all purposes.

### TECHNICAL FIELD

The present disclosure relates to a rechargeable battery. The present disclosure also relates to an interlayer disposable between an anode and a cathode of the rechargeable battery, wherein the interlayer inhibits growth of one or more dendrites in a direction from the interlayer to the cathode.

### BACKGROUND

Rechargeable batteries may be widely used as power sources for various electronic devices, including electric vehicles (EVs), cell phones and laptops. They have also found applications in electric vehicles and grid storage. In spite of their wide use, concerns over the safety of rechargeable batteries remain. For example, many fires/explosions associated with use of rechargeable batteries seem to have occurred in the last decade.

The three primary components of rechargeable batteries are the cathode, anode and electrolyte. Practically, the cathode and anode are typically electronically isolated by a thin porous separator. The separator may be filled with the electrolyte to provide ionic conductivity. Depending on the electrochemical reactions between the cathode and anode, various kinds of rechargeable batteries have been developed, such as lithium-ion, lithium-sulfur, lithium-air, sodium ion, sodium-sulfur, sodium-air, and zinc-air batteries. Some of these batteries employ ionic host materials for both cathodes and anodes (e.g. lithium-ion and sodium-ion batteries). They may hence be considered metal-free batteries. Other batteries may use metal as anodes (e.g. lithium-sulfur, lithium-air, sodiumsulfur, sodium-air, and zinc-air batteries). In various cases, rechargeable batteries have a serious problem regarding the growth of metallic dendrites. This is a major cause of battery safety issues.

For example, in lithium-ion batteries, even though they are designed and manufactured as lithium-metal-free batteries, lithium metal may still be deposited on the anode during charging (reduction at the anode side) under harsh conditions, such as overcharge and excessive currents. The deposited lithium may grow across the separator in the form of dendrites. This may lead to internal short circuits as the two electrodes are bridged by the lithium dendrites, and results in safety issues.

Similarly, other metal-free rechargeable batteries suffer from potential growth of metallic dendrites that causes safety issues, such as sodium-ion batteries.

Different metallic dendrites may grow depending on the electrochemistry of the rechargeable battery. For instance, lithium and sodium dendrites may grow in lithium- and sodium-ion batteries, respectively. Compared to metal-free batteries, the dendrite problem may be even more serious for some rechargeable batteries that are based on metallic anodes, such as lithium, sodium, and zinc. This may be because metallic dendrites grow more easily in these metal-anode-based batteries during cycling. In fact, commercialization of these metal-anode-based batteries remains inhibited and one of the main reasons tends to be the safety associated with the growth of the metallic dendrites.

To overcome the growth of metallic dendrites in rechargeable batteries, many efforts have been devoted to develop dendrite-free metallic plating techniques by using modified and advanced electrolytes and separators, as well as by altering electrode/electrolyte interfaces using in-situ formed or artificial films. Modified and advanced solid/polymer electrolytes, separators and artificial films were also used to physically suppress the growth of dendrites. Although these approaches can help improve the stability of metallic anodes and improve the cycle life/shelf life of rechargeable batteries, none of them may completely overcome the growth of dendrites. Alternatively, researchers have proposed to remove metallic dendrites by reacting with a chemically active layer which is placed between the cathode and the anode, and electronically isolated from the anode. Such a chemically active layer tends to be effective to a limited extent as it tends to only react with a limited amount of metallic dendrite, given a thickness of the active layer. This is because after the local points of the chemically active layer (the points that contact metallic dendrites) and the parts nearby that react with the metallic dendrites, there remains full of metallic ions, and metallic dendrites continue to grow and reach the cathode, resulting in shorting. In short, the control of growth of metallic dendrites remains a challenge for rechargeable batteries suffering from dendrite issues.

There is thus a need to provide for a solution that resolves and/or ameliorate the issues mentioned above. The solution should at least improve safety of using and charging rechargeable batteries.

### SUMMARY

In a first aspect, there is provided for a rechargeable battery comprising:

an anode;

a cathode;

an electrolyte in contact with the anode and the cathode; and

an interlayer disposed between the anode and the cathode in the electrolyte, wherein the anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode.

In another aspect, there is provided for an interlayer disposable between an anode and a cathode in an electrolyte of a rechargeable battery, wherein the anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode.

### BRIEF DESCRIPTION OF THE DRAWINGS

The drawings are not necessarily to scale, emphasis instead generally being placed upon illustrating the principles of the invention. In the following description, various embodiments of the present disclosure are described with reference to the following drawings, in which:

FIG. 1A is a schematic diagram of a testing cell with an active FeOOH layer at the first lithium dendrite growth stage. This is discussed in example 1B.

FIG. 1B is a schematic diagram of a testing cell with an active FeOOH layer at the second lithium dendrite growth stage. This is discussed in example 1B.

FIG. 1C shows the voltage profiles between different terminals of the cell at a current of 4 mA cm⁻². As long as the FeOOH layer has a potential higher than the lithium plating potential, the growth of lithium dendrites can be suppressed at this layer.

FIG. 2A is a schematic diagram of a testing cell without an active layer at the first lithium dendrite growth stage. This is discussed in comparative example 1.

FIG. 2B is a schematic diagram of a testing cell without an active layer at the second lithium dendrite growth stage. This is discussed in comparative example 1.

FIG. 2C shows the voltage profiles between different terminals of the cell at a current of 4 mA cm⁻².

FIG. 3A is a schematic diagram used to demonstrate the design and working principle of the present double-anode approach. Specifically, FIG. 3A depicts a conventional cell configuration. Dendrites grow past through the separator resulting in a short circuit of the cell.

FIG. 3B is a schematic diagram showing the design and working principle of the present double-anode approach. Specifically, FIG. 3B shows a cell with an interlayer placed between but electronically isolated from the cathode and the anode. The growth of dendrites stopped at the interlayer because Li⁺ ions electrochemically react with the second anode instead of dendrites growing.

FIG. 4 shows a model for simulations of current and potential distributions on a second anode bridged with a lithium dendrite in the center during charging.

FIG. 5A shows comparison of the electrolyte-soaked separators with and without the FeOOH layer used in FIGS. 1A and 2A, respectively. Specifically, FIG. 5A shows a Nyquist plot of electrochemical impedance spectroscopy (EIS) measurements performed on the cells with and without the FeOOH layer.

FIG. 5B schematically shows the cells used for measurements without the FeOOH layer. The resistance is about 2.6Ω for the cell without the FeOOH layer.

FIG. 5C schematically shows the cells used for measurements with the FeOOH layer. The resistance is about 3.5Ω for the cell with the FeOOH layer. When a discharge current of 4 mA cm⁻² flows though the separator, the increased resistance of the cell with the interlayer creates a voltage drop of about 1 mV compared with the one without the interlayer in FIG. 5B. Such a minor voltage drop is negligible for practical applications.

FIG. 6A is a comparison of cell performance with and without the FeOOH layer used in FIGS. 1A and 2A, respectively. A LiNi_{1/3}Co_{1/3}Mn_{1/3}O₂ (NCM, 3M Company) electrode was used as the working electrode, and a lithium metal was used as the counter electrode, for measurements. Specifically, FIG. 6A shows a comparison of typical charge/discharge curves at 30 mA g⁻¹.

FIG. 6B shows a comparison of cell performance with and without the FeOOH layer used in FIGS. 1A and 2A, respectively. Specifically, FIG. 6B shows a comparison of rate capability and cyclability. The results show that the separator with the FeOOH layer (PE/FeOOH/Au/PE) does not compromise the cell performance compared with the pure polyethylene (PE), in terms of capacity and rate capability. Moreover, the separator with the interlayer supports better cyclability.

FIG. 7 shows a scanning electron microscopy (SEM) image of gold coated PE, particularly depicting the porous structure of the separator. Scale bar denotes 1 μm.

FIG. 8 shows a Nyquist plot of an EIS measurement performed on the Au coating side of the Au coated PE with a width (W) of 0.65 cm and a length (L) of 0.45 cm. The resistance (R) is about 9.1Ω according to the measurement. The sheet resistance (Rₛ) is calculated to be 6.3Ω se according to the equation: Rₛ=RW/L.

FIG. 9 shows a SEM image of the FeOOH used in the experiment. The FeOOH has a rod-like shape. Scale bar denotes 1 μm.

FIG. 10 shows a transmission electron microscopy (TEM) image of the FeOOH used in the experiment. The FeOOH has a rod-like shape. Scale bar denotes 0.2 μm.

FIG. 11A shows the morphology of the prepared FeOOH coating layer. Specifically, FIG. 11A shows a SEM image of the FeOOH coating layer. In addition to the rod-like FeOOH, nanoparticles of Super P carbon additive can also be found. Scale bar denotes 2 μm.

FIG. 11B shows the capacity of the prepared FeOOH coating layer. Specifically, FIG. 11B shows the 1^{st} discharge capacity of the prepared FeOOH coating layer on the PE. The FeOOH coating has a high capacity of about 3.5 mAh cm⁻² at a current of 4 mA cm⁻²

FIG. 12A is a photograph of the thickness measurement of pure PE. The thickness measured is 0.011 mm.

FIG. 12B is a photograph of the thickness measurement of FeOOH coated PE. The thickness measured is 0.040 mm.

### DETAILED DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and changes may be made without departing from the scope of the invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure provides for a strategy that suppresses growth of metallic dendrites in rechargeable batteries by electrochemically reactions between the interlayer and ions from the cathode. The present strategy may involve an interlayer that can electrochemically suppress growth of metallic dendrites in rechargeable batteries. The present strategy improves the safety of using rechargeable batteries and charging rechargeable batteries.

Metal tends to form at an anode of a rechargeable battery when being charged. As an example, lithium metal tends to form on the anode in a lithium-ion battery (LIB). Over the course of charging, the amount of metal formed on the anode grows. The growing metal is referred to herein as metal or metallic dendrites. The dendrites grow from the anode as more metal forms thereon and extend toward the cathode over the course of charging. Once the dendrites contact the cathode, electrons from the anode can transmit to the cathode via the dendrites. The dendrites form a bridge that electronically couples the anode to the cathode, creating a short circuit in the rechargeable battery. This short circuit gives rise to safety issues that include fire and/or explosion of rechargeable batteries. The term “electronically couple”, and its grammatical variants, used herein means at least two components are connected such that electrons can flow between the components.

The present strategy advantageously circumvents internal short circuit resulting from growth of, for example, lithium dendrites. Growth of lithium dendrites from the low-potential anode is a cause for safety issues of LIBs. Fully addressing the growth of lithium dendrites remains a great challenge. The present strategy may be considered a “double-anode” approach to completely stop the growth of lithium dendrites. The present strategy introduces an interlayer that can act as a second anode in LIBs only when there is growth of lithium dendrites and the dendrites are in contact with the interlayer. After dendritic growth, Li⁺ ions may be consumed by the second anode instead of dendrites growing to reach the cathode, which otherwise may lead to a short circuit as already explained above. With this advantage of suppressing growth of lithium dendrites, the present strategy reduces the self-immolation incidence of EVs, cellphones, laptops and other devices that use LIBs.

Accordingly, various embodiments of the first aspect relates to a rechargeable battery comprising an anode, a cathode, an electrolyte in contact with the anode and the cathode, and an interlayer disposed between the anode and the cathode in the electrolyte, wherein the anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode. The cations may comprise lithium ions.

The cathode may act as the source for cations, e.g. metal cations such as Li⁺ ions, depending on the material used for forming the cathode. For example, when sulfur and V₂O₅ are used as cathode materials, they do not contain Li⁺ ions initially. However, after the first discharge of a rechargeable battery, such cathodes may be lithiated and contain Li⁺ ions. Nevertheless, the cathode may be operable to produce cations, e.g. metal cations such as lithium ions, during charging.

The rechargeable battery may be connected to an external power supply to be charged. When charging the rechargeable battery, oxidation occurs at the cathode and results in production of cations such as lithium ions. The cathode is hence operable to produce lithium ions. In a typical rechargeable battery that is being charged, the lithium ions migrate in the electrolyte in a direction from the cathode to anode, and deposit as lithium metal on the anode, resulting in growth of one or more lithium dendrites over the course of charging. Lithium ions already present in the electrolyte may also migrate to the anode to be deposited thereon, resulting in growth of one or more dendrites during charging of the rechargeable battery. The one or more lithium dendrites may grow in the direction from the anode toward the cathode. The present interlayer inhibits this growth.

The present interlayer is disposed between the anode and cathode, and electronically isolated from both anode and cathode. This means the anode and cathode are not in direct contact with the interlayer. Otherwise, a short circuit occurs. The arrangement of the present interlayer does not render the interlayer a barrier that physically blocks dendrites from growing toward the cathode. The interlayer is also not a barrier that only chemically reacts with dendrites to stop the dendrites' growth. Rather, the present interlayer is configured to comprise one or more active materials. The interlayer containing such an active material that may electrochemically react with lithium ions to stop the growth of lithium dendrites. The term “electrochemically react”, and its grammatical variants, are distinguished from typical chemical reactions that involve a reaction of one material with another without need for external electrons to be supplied. The term “electrochemically react” used herein means that external electrons are supplied to the interlayer for which the active material in the interlayer then reacts with cations such as Li⁺ ions to prevent growth of, for example, lithium dendrites. The present interlayer may be termed an “active layer” as it comprises one or more of such active materials.

The one or more active materials may comprise Si, Sn, Al, Sb, P, graphite, amorphous carbon, SnSb, SnO, SnO₂, MnO₂, V₂O₅, TiO₂, FeO, Fe₃O₄, Fe₂O₃, FeOOH, FePO₄, NiCo₂O₄, SnS, SnS₂, Sb₂S₃, NiS, Ni₃S₂, CoS₂, CuS, FeS₂, NiP₃, or a combination thereof. Such active materials are able to electrochemically react with cations, e.g. lithium ions, to prevent dendrite growth in the direction of the cathode.

The interlayer, comprising one or more of the active materials, receives electrons from the anode for the one or more active materials comprised in the interlayer to electrochemically react with the cations when the one or more dendrites contact the interlayer. As mentioned above, one or more dendrites may grow from the anode when charging a rechargeable battery. The dendrites may come into contact with the interlayer when growing in the direction of the cathode. When the dendrites contact the interlayer, the dendrite forms a bridge that electronically couples the anode and the interlayer, and electrons from the anode can flow to the interlayer via the dendrites. Contact of a dendrite with the interlayer renders the interlayer electronically conductive. This renders the interlayer a “second anode” only when one or more dendrites contact the interlayer and hence the present strategy may be referred herein as a “double-anode” approach.

Electrons supplied to the interlayer provides for the active material to electrochemically react with lithium ions to stop lithium from plating on the interlayer that can result in one or more dendrites growing from the interlayer to the cathode. The interlayer's contact with one or more dendrites renders the interlayer electrochemically active. When no contact is established, the interlayer is not electrochemically active and no electrochemical reaction takes place.

The interlayer is versatile in that it may comprise an active material layer that may be electronically non-conductive or electronically conductive. A layer containing the active material may be termed herein an “active material layer”. An interlayer having an electronically non-conductive active material layer does not mean the interlayer is unable to suppress dendrite growth. Interlayers having an active material layer that is electronically non-conductive may still provide for electrochemical reactions that consume the lithium ions, as one example of the cations. For example, an interlayer that has an electronically non-conductive active material layer may be designed to have or to be combined with an electronically conductive medium that renders the interlayer electronically conductive.

The interlayer may be configured to be electronically conductive. For an electronically conductive interlayer, the entire interlayer provides for electrochemical reactions that consume cations, e.g. lithium ions, even if one or more dendrites come into contact with the interlayer only at certains parts as electrons can easily flow throughout the electronically conductive interlayer.

The interlayer may be formed of an ionically conductive material. The interlayer can become ionically conductive after it is filled with or adsorbs electrolyte. This means the interlayer becomes wetted with the electrolyte. An ionically conductive interlayer allows lithium ions to flow through interlayer between anode and cathode for normal operation of a rechargeable battery. The term “ionically conductive” used herein means that the material allows conduction (e.g. mobility) of ions.

The interlayer may be porous. A porous interlayer allows the filling of an electrolyte in the interlayer, which enhances cations, e.g. Li⁺ ions, transport across the interlayer.

The interlayer may be non-porous. Non-porous interlayer can still be ionically conductive. For example, the interlayer may be formed of polymers that swell when the interlayer is contacted with an electrolyte in a battery. Swelling of polymers renders the interlayer to become ionically conductive. Such interlayers, after swelling with an electrolyte, absorb the electrolyte and become ionically conductive.

The present interlayer may comprise at least one electronically conductive medium, wherein the electronically conductive medium comprises copper, gold, nickel, stainless steel, conductive carbon, conductive polymer, or a combination thereof. The electronically conductive medium may be disposed adjacent to a layer containing the active material. Such a layer containing the active material may be termed herein an “active material layer” as already mentioned above. The electronically conductive medium helps to enhance conduction of electrons in the interlayer. The electronically conductive medium renders an interlayer having an electronically non-conductive active material layer electronically conductive. The electronically conductive medium may also be used to establish electrical contact to external devices, such as voltmeter for measuring voltage across the interlayer.

The interlayer may be electronically isolated from the anode and cathode as mentioned above. The interlayer may be electronically isolated from the anode and/or the cathode by using a separator. The interlayer may be electronically isolated from the anode and/or the cathode by a separator positioned between (i) the anode and the interlayer and/or (ii) the cathode and the interlayer, respectively. This helps to avoid direct contact between the interlayer and anode, direct contact between the interlayer and cathode, and/or direct contact between the anode and cathode via an interlayer. For the purpose of illustration, non-limiting examples on the arrangement of the active material layer, separator and electronically conductive medium may be (i) separator/conductive medium/active material layer/separator, (ii) separator/active material layer/conductive medium/separator, (iii) separator/conductive medium/active material layer/conductive medium/separator, or (iv) separator/conductive medium/active material layer/separator/conductive medium/active material layer/separator. In these configurations, the interlayer may comprise the electronically conductive medium and active material layer. Example (iv) demonstrates at least one interlayer may be incorporated in the present rechargeable battery. The non-limiting examples demonstrate that the various components may be formed contiguous (i.e. in physical contact) to each other. This is advantageous for reducing total thickness of the rechargeable battery. With a lower thickness, internal resistance of the battery is not significantly compromised.

The separator may be configurable into an ionically conductive membrane. The separator may become ionically conductive when it is soaked in the electrolyte. The separator may also be of an ionically conductive material. This allows for lithium ions to pass through for normal operation of a battery. The separator may comprise polyethylene, polypropylene, or a combination thereof. Other commercially suitable separators may also be used.

The separator may serve as a substrate which the interlayer may be disposed on. This means the interlayer may be formed as a free-standing layer and does not require additional substrates to be combined with the interlayer. As the interlayer can be formed directly on the separator, no intermediary layer is required between the separator and interlayer, which helps to keep the rechargeable battery compact. Without an intermediary layer, there is no additional resistance or thickness to the rechargeable battery.

The interlayer is not restricted to a particular form. The interlayer may be a free-standing layer, combinable with a substrate, be a multi- or single-layered layer.

The interlayer may be configured to comprise a binder. The binder helps to hold the one or more active materials together in the interlayer so that the active material does not disperse or leach out from the interlayer when immersed into an electrolyte. The binder may also hold the interlayer together when the interlayer is formed of multiple layers. The binder may comprise polyvinylidene fluoride, polyvinylidene fluoride-co-hexafluoropropylene, polyethylene oxide, polytetrafluoroethylene, polyurethane, polyacrylonitrile, polytetraethylene glycol diacrylate, polymethylmethacrylate, sodium carboxymethyl cellulose, or a combination thereof.

The rechargeable battery is operable to have (i) the interlayer maintain a potential which is higher than a potential of Li⁺/Li when charging the rechargeable battery, and (ii) the one or more dendrites withdraw from the interlayer toward the anode when discharging the rechargeable battery.

For (i), the interlayer is configured to electrochemically react with lithium ions, e.g. those present in the electrolyte, upon electronic coupling between the anode and the interlayer. The electrochemical reaction, which involves consumption of lithium ions and inhibits dendrites' growth, occurs as the interlayer has a potential that is higher than the potential of Li⁺/Li. Any material, or active material, that can electrochemically react with Li⁺ has a potential higher than Li⁺/Li. The potential of the interlayer may always be higher than the potential of Li⁺/Li when the battery works normally, even during discharge.

For (ii), the interlayer does not dissolve the dendrites to have them withdrawn back toward the anode during discharging of the rechargeable battery. As already described above, the interlayer consumes lithium ions from the cathode through the electrolytes, as the interlayer provides for inhibiting further growth of dendrites during charging of the rechargeable battery. Rather, during discharging, the dendrites get electrochemically oxidized and dissolved first since it has a lower oxidation potential than the interlayer. Dissolution of the dendrites causes them to withdraw away from the interlayer and cuts off electron supply to the interlayer.

The rechargeable battery having the present interlayer may be operated at a voltage (e.g. between the anode and interlayer) ranging from 0 to 3.5 V (with reference to Li⁺/Li) and/or at a current ranging from 0.02 to 100 mA/cm². The operation of the rechargeable battery having such interlayer need not be restricted to such operating conditions as long as the interlayer can electrochemically react with lithium ions.

The interlayer may be configured to comprise or may have an areal capacity ranging from 10% to 150% of that of the cathode or anode. The areal capacity provided by the interlayer may be customisable with respect to the areal capacity of the cathode or anode, as capacity of the interlayer depends on capacity of the electrodes (e.g. lithium ion source). This renders the present rechargeable battery more advantageous as electrodes of conventional batteries tend to be limited to an areal capacity ranging from 1 to 4 mAh/cm².

The interlayer is configured to comprise or may have a thickness of 2 mm or less, 0.5 mm or less, 0.2 mm or less, 0.1 mm or less, 0.05 mm or less, 0.03 mm or less, etc. This is advantageous as incorporation of the present interlayer does not increase size of a rechargeable battery. This also signifies that the interlayer need not be thicker to maintain comparable performance of a rechargeable battery, e.g. in terms of capacity etc. An interlayer of such thickness also avoids increasing internal resistance unnecessarily. Nevertheless, if necessary, the thickness of the interlayer may be increased up to, for example, 6 mm. In such instances, the interlayer may have a thickness of 6 mm or less.

The present disclosure also provides for an interlayer disposable between an anode and a cathode in an electrolyte of a rechargeable battery, wherein the anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode. The cations may comprise lithium ions.

Embodiments and advantages described above in relation to the rechargeable battery are applicable and/or valid to the present interlayer and its various embodiments, and vice versa.

For example, as already described above, the interlayer may be configured to comprise one or more active materials. The one or more active materials may comprise Si, Sn, Al, Sb, P, graphite, amorphous carbon, SnSb, SnO, SnO₂, MnO₂, V₂O₅, TiO₂, FeO, Fe₃O₄, Fe₂O₃, FeOOH, FePO₄, NiCo₂O₄, SnS, SnS₂, Sb₂S₃, NiS, Ni₃S₂, CoS₂, CuS, FeS₂, NiP₃, or a combination thereof.

The interlayer may receive electrons from the anode for the one or more active materials comprised in the interlayer to electrochemically react with the cations, e.g. lithium ions, when the one or more dendrites contact the interlayer. The interlayer may have an active material layer that may be electronically non-conductive and the interlayer may be configured to be electronically conductive. An interlayer having an active material layer that is electronically non-conductive may contain an electronically conductive medium that renders the interlayer electronically conductive, as already described above. The interlayer may be porous or may be non-porous. The interlayer may comprise at least one electronically conductive medium, wherein the electronically conductive medium comprises copper, gold, nickel, stainless steel, conductive carbon, conductive polymer, or a combination thereof. The electronically conductive medium may be disposed adjacent to the layer containing the active material, as an example. The interlayer may be a free-standing layer or disposed on a substrate. The substrate may comprise a separator which may be configurable into an ionically conductive membrane. The separator may comprise polyethylene, polypropylene, or a combination thereof. Embodiments and/or advantages of these features associated with the interlayer has already been described above in various embodiments of the first aspect and shall not be iterated for brevity.

As already mentioned above, the interlayer may comprise a binder. The binder may comprise polyvinylidene fluoride, polyvinylidene fluoride-co-hexafluoropropylene, polyethylene oxide, polytetrafluoroethylene, polyurethane, polyacrylonitrile, polytetraethylene glycol diacrylate, polymethylmethacrylate, sodium carboxymethyl cellulose, or a combination thereof.

The interlayer may be configured to comprise a thickness of 2 mm or less, 0.5 mm or less, 0.2 mm or less, 0.1 mm or less, 0.05 mm or less, 0.03 mm or less, etc. The advantage for such thickness has already been described above in various embodiments of the first aspect and shall not be iterated for brevity. The interlayer may also have a thickness of 6 mm or less.

The word “substantially” does not exclude “completely” e.g. a composition which is “substantially free” from Y may be completely free from Y. Where necessary, the word “substantially” may be omitted from the definition of the invention.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

While the methods described above are illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

### EXAMPLES

The present invention is directed to at least an interlayer that can electrochemically suppress the growth of metallic dendrites in rechargeable batteries. Suppression of growth of metallic dendrites in rechargeable batteries occurs via electrochemically reactions between the interlayer and metal ions from the cathode. The interlayer may include multiple layers and have at least one active material. The at least one active material can electrochemically react with lithium ions from the cathode. After filling or adsorbing electrolytes, the interlayer becomes ionically conductive. The layer containing the active material, as already described above, may be termed an “active material layer”.

The interlayer that electrochemically suppresses growth of metallic dendrites in rechargeable batteries advantageously improves safety of using and charging rechargeable batteries. The interlayer and anode in the batteries may be electronically isolated by a separator or an ionically conductive membrane. When metallic dendrites grow from the anode and continues through and/or from the separator, e.g. an ionic conductive membrane, to reach the interlayer during charging, electrons are supplied from the anode to the interlayer through the dendrite bridges. The interlayer may then be considered an “additional anode” (i.e. when a dendrite is in contact with the interlayer). Electrochemical reductions may take place on the interlayer. Ions (e.g. Li⁺ in lithium-ion batteries) coming from the cathode side may electrochemically react with the interlayer instead of growing dendrites because it is thermodynamically configured (i.e. the potential of the electrochemical reaction between the interlayer and the ions is always higher than that of metal plating). Once the interlayer is reduced and consumes ions during charging, it may become difficult for it to be oxidized to release the ions again during discharging (i.e. use of the battery). This is because, during discharging, metallic dendrites are electrochemically oxidized and dissolved first since it has a lower oxidation potential than the interlayer. The interlayer may have no electron supply due to loss of the dendrite bridges. If the interlayer has a sufficient capacity to take all the ions originally from the cathode during shorting, the battery may lose all the active ions source (e.g. Lit) in the electrodes. The safety issues caused by the dendrites are then advantageously avoided.

The present invention uses electrochemical reactions between the interlayer and the cathode to suppress the growth of dendrites. This is in principle different from those suppressing dendrites by other chemical reactions between a chemically active layer and dendrites. It is also different from those physically suppressing the growth of dendrites.

The present rechargeable battery and interlayer are described by way of non-limiting examples as set forth below.

### Example 1A: Summary of Materials and Configuration of the Interlayer

The active materials in the at least one interlayer may be any material that can electrochemically react with the ions from the cathode. For example, for lithium-ion and lithium-metal-based batteries, the active materials in the interlayers may include Si, Sn, Al, Sb, P, graphite, amorphous carbon, SnSb, SnO, SnO₂, MnO₂, V₂O₅, TiO₂, FeO, Fe₃O₄, Fe₂O₃, FeOOH, FePO₄, NiCo₂O₄, SnS, SnS₂, Sb₂S₃, NiS, Ni₃S₂, CoS₂, CuS, FeS₂, and NiP₃. The active materials may have a high capacity and low potential vs. lithium deposition potential, such as Si, Sn, Al, Sb, P, amorphous carbon, SnSb, SnO, SnO₂, FeO, Fe₃O₄, Fe₂O₃, FeOOH, NiCo₂O₄, SnS, SnS₂, Sb₂S₃, NiS, Ni₃S₂, CoS₂, CuS, FeS₂, and NiP₃.

The interlayer may comprise multiple layers and may include at least one active material layer that contains at least one active material. The interlayer may have an active material layer that may be electronically conductive or electronically non-conductive. In addition to the active material layer, the interlayer may include an electronically conductive medium for improving electronic conductivity. Such a design may allow whole or at least a part of the active layers of the interlayer to electrochemically react with ions from the cathode when the interlayer is bridged with dendrites. An interlayer having an electronically non-conductive active material layer may contain the electronically conductive medium.

The interlayers may be porous or non-porous.

Without filling or adsorbing electrolytes, the interlayers may be ionically conductive or ionically non-conductive. After filling or adsorbing electrolytes, ionically non-conductive interlayers may become ionically conductive.

The interlayers can be free-standing or coated on or incorporated into substrates such as a separator, which may be an ionic conductive membrane. For interlayers having multiple layers, different layers may be prepared separately and combined together into the batteries.

The interlayers may contain an electronically conductive media, such as copper, nickel, stainless steel, or conductive carbons. The conductive media may be films coated on active layers of the interlayers and/or may be films coated on separators or ionic conductive membranes. The conductive media may also be membranes, meshes, and/or foams combined with the active layers of the interlayers. The conductive media may also be particles and/or conductive polymers incorporated in the active material layer of the interlayers.

The interlayers may include binders for improving integrity of the interlayers. Suitable binders may include, for example, polyvinylidene fluoride (PVDF), polyvinylidene fluoride-co-hexafluoropropylene (PVDF-HFP), polyethylene oxide (PEO), polytetrafluoroethylene (PTFE), polyurethane, polyacrylonitrile (PAN), polytetraethylene glycol diacrylate, polymethylmethacrylate (PMMA), polymethylmethacrylate, and sodium carboxymethyl cellulose.

One non-limiting example of the interlayer, and its features, may be described as follows.

An interlayer that can electrochemically suppress the growth of metallic dendrites in rechargeable batteries may comprise (1) at least one active layer that contains at least one active material that can electrochemically react with ions from the cathode, and (2) is electronically conductive. The interlayer may be in the form of a single layer or multiple layers. The interlayer may be free-standing, or combined with or incorporated into a substrate. The substrate may be a separator that is configurable into an ionic ally conductive membrane.

The interlayer may include at least one electronically conductive medium, such as copper, nickel, stainless steel, conductive carbons. The electronically conductive medium may be in the form of a particle, in a polymer incorporated in the active material layer of the interlayer, a membrane, a mesh, or a foam. The electronically conductive medium may be free-standing, combined with the active material layer of the interlayer, a film coated on the active material layer of the interlayer, a film coated on a substrate. The substrate may be a battery separator, or an ionically conductive membrane configured from the separator.

The interlayer may further include at least a binder to maintain the structure integrity. The binder may be polyvinylidene fluoride (PVDF), polyvinylidene fluoride-co-hexafluoropropylene (PVDF-HFP), polyethylene oxide (PEO), polytetrafluoroethylene (PTFE), polyurethane, polyacrylonitrile (PAN), polytetraethylene glycol diacrylate, polymethylmethacrylate (PMMA), polymethylmethacrylate, or sodium carboxymethyl cellulose.

A non-limiting example of a rechargeable battery having the present interlayer may include a cathode, an anode, an electrolyte, two separators or ionic conductive membranes, and the interlayer described above. The interlayer may be disposed between the separators or ionic conductive membranes. In the rechargeable battery, Li⁺ may be the charge carrier of the battery. During charging, Li⁺ may be released from the cathode, and inserted into the anode or reduced to form metallic lithium. During discharging, the process is reversed.

The active material of the interlayer and rechargeable battery has already been described above. For lithium-ion and lithium-metal-based batteries, Si, Sn, Al, Sb, P, graphite, amorphous carbon, SnSb, SnO, SnO₂, MnO₂, V₂O₅, TiO₂, FeO, Fe₃O₄, Fe₂O₃, FeOOH, FePO₄, NiCo₂O₄, SnS, SnS₂, Sb₂S₃, NiS, Ni₃S₂, CoS₂, CuS, FeS₂, and/or NiP₃ may be used. The active materials may have a high capacity and low potential vs. lithium deposition potential, such as Si, Sn, Al, Sb, P, amorphous carbon, SnSb, SnO, SnO₂, FeO, Fe₃O₄, Fe₂O₃, FeOOH, NiCo₂O₄, SnS, SnS₂, Sb₂S₃, NiS, Ni₃S₂, CoS₂, CuS, FeS₂, and NiP₃.

### Example 1B: Summary on Performance of Present Interlayer

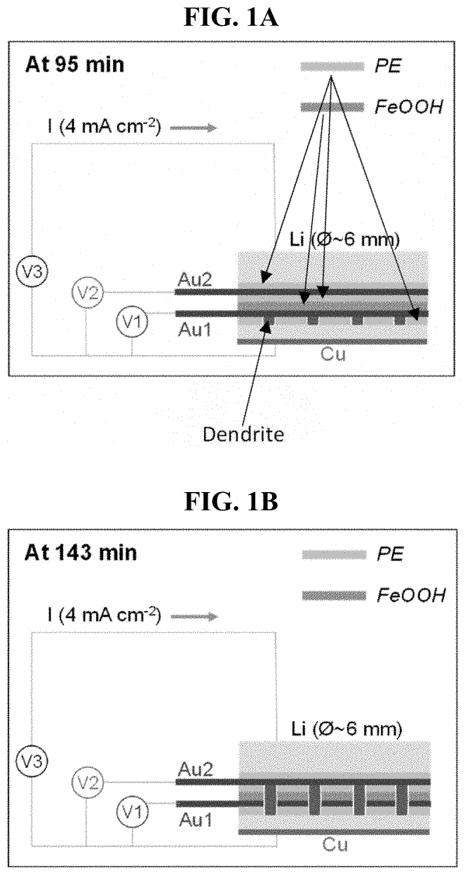

This example is for demonstrating an interlayer having an active material that can electrochemically suppress the growth of lithium dendrite. Schematic diagrams of the testing cell at two different lithium dendrite growth stages are shown in FIGS. 1A and 1B. In the cell, lithium metal was used as the working electrode to serve as a lithium source. Copper was employed as a substrate for lithium plating. Three pieces of a polyethylene (PE) separator were placed between the two electrodes. Two gold conductive layers (Au1 and Au2) were coated on the PE separator and positioned between two pieces of the PE separator and between a piece of separator and an active layer of FeOOH which was also coated directly on Au1, which is on the PE separator. The FeOOH active layer has a capacity of about 3.5 mAh/cm² at a current of 4 mA cm⁻².

To induce growth of lithium dendrites, a relatively high current of 4 mA cm² was applied for lithium plating on the copper substrate. When lithium dendrites grow and reach Au1 (FIG. 1A), the FeOOH active layer has electron supply and starts to take Li⁺ coming from the lithium source and to be electrochemically reduced. The potential of the FeOOH active layer reduces compared to its previous state due to polarization. Simultaneously, lithium plating on the copper electrode may still continue because potential of the copper electrode is lower than 0 V vs. Li⁺/Li. If potential of the copper electrode is higher than 0 V vs. Li⁺/Li, oxidation of the plated lithium and lithium dendrites may occur, and the lithium dendrites gets dissolved. Although lithium may still be plated on the copper electrode, potential of the copper electrode increases. This is due to reduced polarization since reduction (lithium plating) rate on the copper electrode is decreased as part of the reduction occurred on the FeOOH active layer while the total reduction rate is the same (equal to 4 mA cm⁻²). The potential decrease of the FeOOH active layer and potential increase of the copper electrode result in a voltage drop for Au1-Cu (V1). The potential increase of the copper electrode leads to a voltage drop for Au2-Cu (V2) and Li—Cu (V3). As observed (FIG. 1C), during the initial 95 minutes of lithium plating, the three voltage profiles, V1, V2 and V3 are smooth. A sharp voltage drop occurs at 95 minutes for all the three profiles, indicating a first dendrite penetration through the bottom-layer PE separator (FIG. 1A).

After the dendrites penetrate the bottom-layer PE separator and contact the Au1 and FeOOH active layer, the lithium dendrites become unstable. This is because the dendrites react with the FeOOH, and on the other hand the current flowing through the dendrite may melt the dendrites. Such instability of the dendrites causes instability of the potential of the Cu electrode and the FeOOH active layer. This gives rise to the noise in profiles of V1, V2 and V3, as observed in FIG. 1C. Nevertheless, with the bridging by dendrites, the FeOOH gets continuously reduced towards 0 V vs. Li⁺/Li. After the potential of the FeOOH active layer reaches 0 V vs. Li⁺/Li, lithium dendrites may start to grow again on the FeOOH active layer. When the dendrites pass through the middle-layer PE separator and contact Au2 (FIG. 1B), V2 becomes about 0 V. This happens at 143 minutes of the test (48 minutes after the dendrites first short Au1) as shown in FIG. 1C. Therefore, as long as the FeOOH layer has a potential higher than the lithium plating potential, the growth of the lithium dendrites can be stopped at this layer.

### Comparative Example 1: Performance of Battery without Active Layer

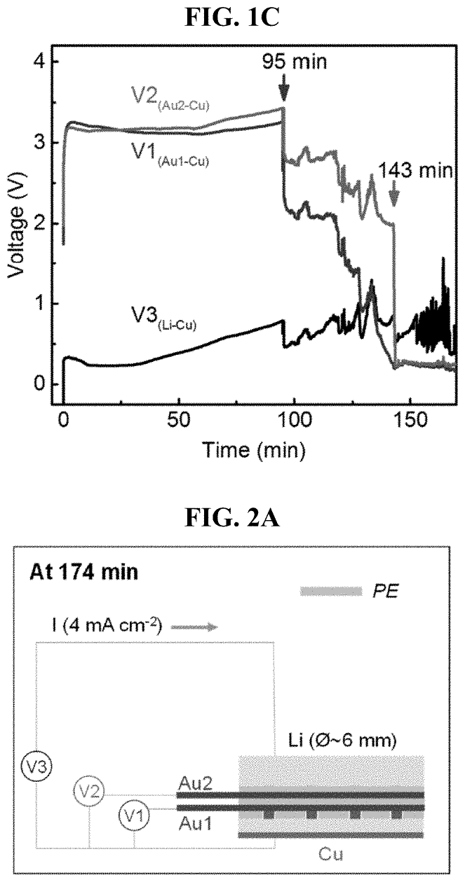

In this comparative example, the cell configuration was the same as in example 1B except for absence of FeOOH active layer. The testing condition was also the same. The schematic diagram and the results are shown in FIG. 2A to 2C. It takes only 6 minutes for dendrites to grow from Au1 to Au2, much less than 48 minutes for the one with the FeOOH active layer in example 1B. This also confirms the effectiveness of the interlayer for suppressing the growth of lithium dendrites.

### Example 2A: Discussion on Design and Working Principle

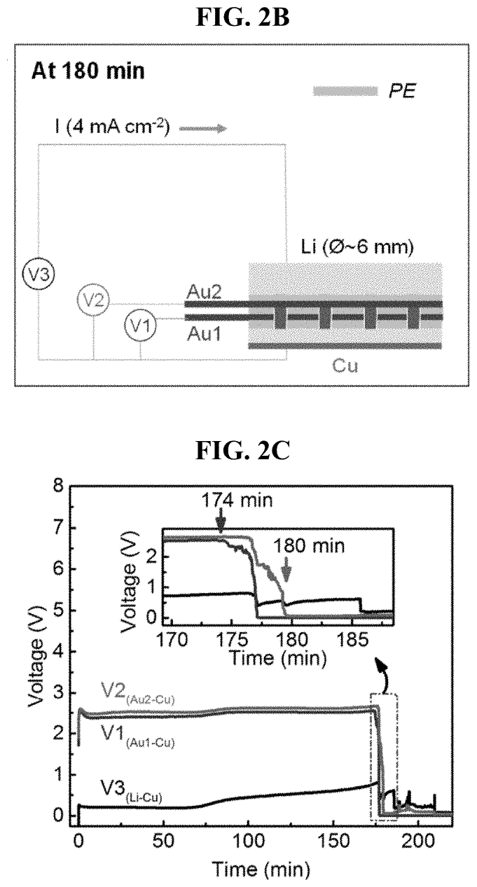

A schematic of the design and working principle of the present approach is shown in FIGS. 3A and 3B. FIG. 3A shows the structure of a conventional battery. A porous separator is sandwiched between the cathode and anode. Once lithium dendrites grow across the separator, the battery is shorted. For the battery structure in the present strategy (FIG. 3B), an interlayer is additionally placed between the cathode and the anode, which is electronically isolated from them by 2 porous separator layers. The interlayer is porous as well to allow the filling of electrolyte for Li⁺ transport. In normal working conditions, the interlayer functions as a part of the separator and no reaction occurs on it. In a battery having such an interlayer, when lithium dendrites grow and reaches it during charging, electrons get supplied from the original anode to the interlayer through the dendrite bridges. Thus, electrochemical reductions take place on the interlayer. Li⁺ ions coming from the cathode side electrochemically react with the interlayer instead of forming into dendrites that grow toward the cathode, as the potential of the electrochemical reaction between the interlayer and Li⁺ is higher than the potential for lithium plating to occur. In other words, electrochemical reaction between the interlayer and Li⁺ ions is thermodynamically favored.

For effectively suppressing growth of lithium dendrite, the interlayer may have a sufficiently high lithium storage capacity so that it consumes a large portion or all of the Li⁺ ions from the cathode. When capacity of the interlayer is the same or more than the capacity of the electrode that acts as the original source of Li⁺ ions (e.g. LiCoO₂ cathode), the interlayer is then able to take all the Li⁺ ions in the electrode. To completely stop the growth of lithium dendrites, the interlayer needs to be able to take all the Li⁺ ions from the cathode. Once the interlayer is reduced and takes Li⁺ ions during charging, it may be difficult for the interlayer to be oxidized to release Li⁺ during discharging. This is because during discharging, lithium dendrites get electrochemically oxidized and dissolved first since it has a lower oxidation potential. The interlayer then has no electron supply due to loss of the dendrite bridging. Therefore, when the interlayer takes all the Li⁺ ions from the cathode (e.g. LiCoO₂) during shorting, the battery loses all the active Li⁺ ions source in the electrodes. The battery then becomes non-chargeable and non-dischargeable. This does not mean that the interlayer shorten the cycle life of a lithium-ion battery (LIB) with lithium dendrites continuously growing during cycling. Because, on the one hand, a LIB with the continuous growth of dendrites during cycling may stop working soon due to the low coulombic efficiency of lithium plating/stripping. It is the lithium plating that results in the growth of dendrites. On the other hand, growth of lithium dendrites in a LIB may signify a potential safety issue of the battery, as a LIB is designed to be a lithium-metal-free battery (e.g. operate normally without short-circuit arising from dendrites growth) during all the charging/discharging processes. It becomes dangerous with the presence of lithium dendrites and use of batteries in such stage should be avoided. In short, whether with or without the interlayer, LIBs' lifespan ends when there is continuous growth of lithium dendrites during cycling. With the interlayer, self-immolation of LIBs caused by internal short circuits of dendrites are prevented. Thus, LIB s with an interlayer described herein has a significant advantage of improved safety. This is particularly important for EVs and grid storage since the short circuit in a single cell may cause fire to the whole battery group.

The interlayer may be composed of or may comprise an electronically conductive layer. Advantageously, the present interlayer may include an active material layer that is electronically conductive or electronically non-conductive. For an interlayer having an active material layer that is of low electronic conductivity or is electronically non-conductive, an electronically conductive medium can be included for the interlayer to electrochemically react with Li⁺ ions when dendrites that grow and comes into contact with the interlayer. Said differently, an interlayer having an electronically non-conductive active material layer may be designed to contain an electronically conductive medium to render the interlayer electronically conductive. For an electronically conductive interlayer, any part that comes into contact with a lithium dendrite can electrochemically react with Li⁺ ions.

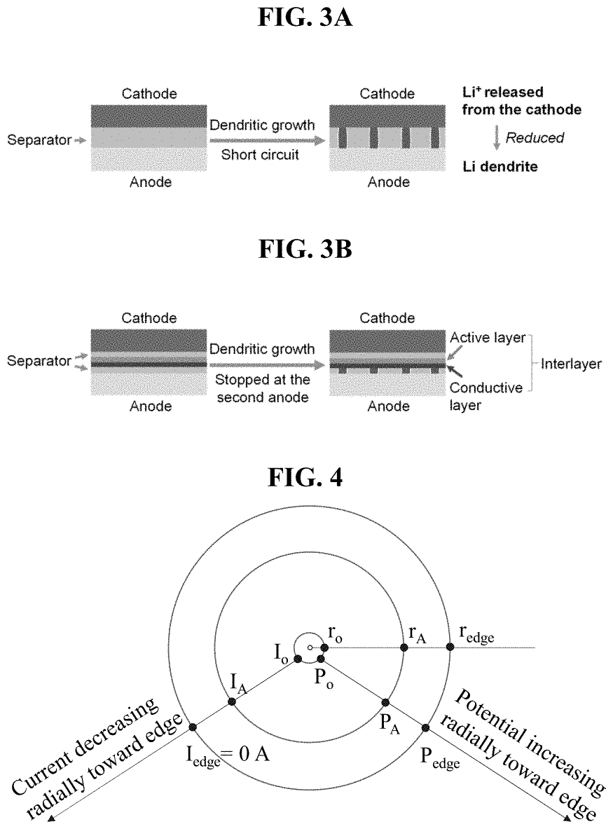

The electronically conductive layer can be a copper layer with a thickness of a few hundreds of nanometers for practical applications. A simulation model (FIG. 4) to discuss the electronic conductivity requirements of the interlayer has been developed. The simulation model is discussed in example 2B below.

A material with a high specific capacity for the interlayer can be used to minimize thickness and/or internal resistance arising from use of the present interlayer. In this regard, silicon is an attractive example because it has one of the highest theoretical lithium storage capacity, i.e. 4200 mAh g⁻¹. Capacities close to or even higher than this have been reported because the decomposition of electrolyte adds an additional capacity. Using silicon as the active material in the interlayer, a capacity loading of 2 to 4 mAh cm⁻² (a typical commercial loading range of LIB electrodes) can be achieved, which may require 0.476 to 0.952 mg cm⁻² of silicon based on theoretical capacity. This corresponds to a thickness of 3.4 to 6.8 μm if the porosity of the silicon layer is 40%. When coupled with 2 pieces of commercially available thin separators (e.g. 6 or 7 μm), the total thickness of the separators and silicon layer amounts to 15.4 to 20.8 μm. Such a thickness may be in the range of those commonly used in commercial batteries and meets the requirements for various applications.

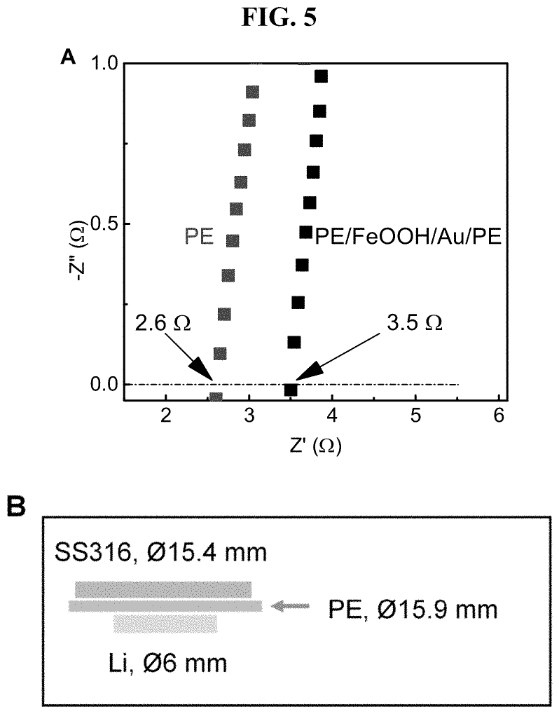

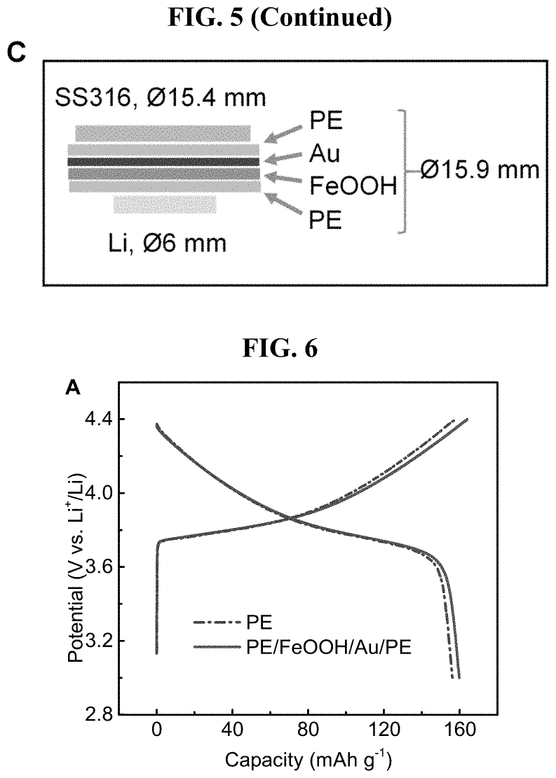

To avoid increase in internal resistance, the interlayer may be sufficiently porous such that a sufficient amount of electrolyte can be filled in it. Commercial separators generally have a porosity of 30 to 60%. Thus, if the interlayer has a porosity of more than 30%, it can have a comparable ionic conductivity to commercial separators when filled with an electrolyte. A porosity of more than 30% for an interlayer can be easily gained because of the gaps between active particles. In certain instances, an additional 2 to 50 μm thick inorganic layer with good ionic conductivity between the 2 electrodes does not compromise the performance of a LIB. This is demonstrated in FIG. 5A to 5C and FIG. 6.

### Example 2B: Simulation Model of Current and Potential Distributions in Interlayer with Dendrites Contact

Conductivity of the interlayer plays a role in the electrochemical reactions that occur over a large part of or the whole of the interlayer. To investigate on this, a simplified model based on a round-shape electrode for current and potential distribution simulations was built. As shown in FIG. 4, when a dendrite bridges the interlayer (round-shape) in the center during charging, a current (Iₒ) will flow though the dendrite due to the electrochemical reaction of the interlayer. Assuming the electrochemical reaction of every part of the interlayer occurs evenly, the current (I_{UA}) generated on a unit area of the interlayer because of the electrochemical reaction can be represented by equation (1) below:

$${I}_{U A} = \frac{{I}_{o}}{π {r}_{e d g e}^{2}}$$

where r_{edge} is the radius of the interlayer.

The current decreases radially toward 0 A at the edge. Thus, the current (I) flowing through a certain circle A (centered at the dendrite spot) of the interlayer can be calculated as set forth in equation (2):

I_{A}=I_{UA}×(πr_{edge}²−πr_{A}²)

where r_{A} is the radius of circle A.

Substituting equation (1) into equation (2), I_{A} can be expressed as equation (3) below:

$${I}_{A} = \frac{{I}_{o}}{π {r}_{e d g e}^{2}} \times ( π {r}_{e d g e}^{2} - π {r}_{A}^{2} ) = {I}_{o} ( 1 - \frac{{r}_{A}^{2}}{{r}_{e d g e}^{2}} )$$

The potential of the spot (in the center) contacting the dendrite is the lowest compared to any other part of the interlayer, and it increases radially toward the edge. The voltage (V_{A}) between any spot of circle A and the dendrite spot can be calculated as set forth in equation (4):

$${V}_{A} = {P}_{A} - {P}_{o} = {\int }_{{r}_{o}}^{{r}_{A}} {I}_{A} \times \frac{{R}_{s}}{2 π r} dr$$

where P_{A} is the potential of circle A, Pₒ the potential of the dendrite edge (about 0 V vs. Li⁺/Li), rₒ the radius of the dendrite, Rₛ the sheet resistance of the interlayer.

Substituting equation (3) into equation (4), VA can be expressed as set forth in equation (5):

$${V}_{A} = {P}_{A} - {P}_{o} = {\int }_{{r}_{o}}^{{r}_{A}} {I}_{o} ( 1 - \frac{{r}^{2}}{{r}_{edge}^{2}} ) \times \frac{{R}_{s}}{2 π r} d r$$

To estimate a potential increase from the dendrite to the edge and to have a general idea about the conductivity requirement of the interlayer, an example with the following parameters: Rₛ=2Ωsq⁻¹; rₒ=10 μm (in a typical dendrite size range), r_{edge}=2.5 cm (such a size is comparable to many types of cell phone battery electrode sheets), capacity loading of the interlayer/electrode: 4 mAh cm⁻² (correspondingly, the total capacity of the sheet is 78.5 mAh and 0.5 C equals 39.3 mA), are used. During charging at a rate of 0.5 C, there is a dendrite bridging the anode and the interlayer. In case of the anode completely failing, the current flowing through the dendrite is 39.3 mA, i.e. Iₒ=39.3 mA. This makes the potential at the edge 0.092 V vs. Li⁺/Li. This is the highest potential on the interlayer. This potential is still sufficiently low for low-potential materials (e.g. silicon, aluminium and tin) to electrochemically react with Li⁺ in LIBs. Thus, Rₛ=2Ωsq⁻¹ is sufficient for many applications. Replacing the Rₛ with 6.3 Ωsq⁻¹ and r_{edge} with 3 mm (the condition for our demonstration experiments), the potential at the edge of the effective lithium plating area is 0.0059 V vs. Li⁺/Li with dendrite shorting in the center. Such a low potential is sufficient for electrochemical reduction of FeOOH.

To achieve a high conductivity/low sheet resistance for practical applications, it may need conductive additives in the interlayer. Introducing an electrochemically conductive layer in the interlayer is also feasible. For example, the sheet resistance of a 0.05 to 0.2 μm thick metallic layer coating such as copper can easily go below 2Ωsq⁻¹. Such a thickness of an electronic conductive layer has little effect on the total thickness of a interlayer.

### Example 3A: Materials and Methods for Demonstration of the Present Interlayer's Effectiveness (Preparation)

A gold layer of about 60 nm was coated on polyethylene (PE) (Entek Gold LP 9 μm using a JEOL JFC-1600 sputtering coater. FeOOH was prepared as follows:

Briefly, 10 mL of 0.5 M aqueous FeCl₃ (Sigma-Aldrich) was added into 70 mL of H₂O in a 100 mL plastic bottle with a 0.8 mm needle hole. After shaking for 1 to 2 mins, the bottle was kept in an oven at 100° C. for 24 hrs. The precipitates were collected after cooling down and washed with deionized water and ethanol several times and finally dried at 80° C. overnight. 31.3 mg of the obtained FeOOH, 5.9 mg of Super P carbon additive (15 wt %), and 2.0 mg of polyvinylidene fluoride (PVDF, 5 wt %) were dispersed in about 3.1 mL of N-methyl-2-pyrrolidone (NMP) and about 7 mL of acetone by ultrasonication. Vacuum filtration of the dispersion was applied to coat a FeOOH layer (average thickness about 4 cm) on a pure PE separator and the gold coating side of the gold coated separator. The loading density of the FeOOH is about 2.5 mg cm⁻².

In the method for preparing a cell comprising the present interlayer, a sputtering method may be utilized for preparing the electronically conducting layer (i.e. medium). For fabrication of the interlayer, a method known to a skilled person used for preparing an electrode may be used.

### Example 3B: Materials and Methods for Demonstration of the Present Interlayer's Effectiveness (Characterization)

Field emission scanning electron microscopy (SEM) images were collected on JEOL JSM-6340F. High-resolution transmission electron microscopy (HRTEM) images were observed using a JEOL JEM 2010 microscope. The thickness of the PE and the FeOOH coated PE was measured by a caliper (Mitutoyo Corp., USA) with an accuracy of 1 μm. Electrochemical impedance spectroscopy (EIS) measurement was performed to measure the sheet resistance of the gold coated separator on a Bio-Logic SP-150 potentiostat in a frequency range of 1 MHz to 100 Hz with an AC amplitude of 10 mV.

### Example 3C: Materials and Methods for Demonstration of the Present Interlayer's Effectiveness (Electrochemical Measurements)

The capacity of the FeOOH coated on PE was determined in a coin cell (CR2032) with a lithium metal as the counter electrode. The demonstration of the effectiveness of the double anodes approach was performed in an argon-filled glove box with a cell constructed by glass slides and sealed with Kapton tape. Detailed cell configurations are introduced along with the results. The electrolyte used for all the cells was 1 M LiPF6 in ethyl carbonate (EC)/diethyl carbonate (DEC)/dimethyl carbonate (DMC) (4:3:3 by volume) (MTI Corp.). All the separator used in this work is a PE separator (Entek Gold LP 9 μm). All the cells were assembled in argon-filled glove box. Galvanostatic discharge/charge and voltage monitor were conducted using Battery Testing Equipment (Neware Electronic Co., China).

### Example 3D: Detailed Discussion and Demonstration of the Present Interlayer's Effectiveness

To demonstrate that the interlayer can effectively stop the growth of lithium dendrites, a multiple-electrode-cell was designed and used to conduct an experiment shown in FIG. 1A to 1C. The demonstration is based on evaluation of the voltages between different terminals. The interlayer can electrochemically react with Li⁺ ions when it is bridged with lithium dendrites and the growth of lithium dendrites can be suppressed as long as the interlayer is able to be reduced to consume Li⁺ ions.

In the demonstration, FeOOH and gold were used as the active material and conductive layer of the interlayer, respectively. FIGS. 1A and 1B schematically show the structure of the testing cell with a FeOOH layer at two dendrite growth stages, respectively. The configuration and materials for the cell setup of FIGS. 1A and 1B have been described in example 1B and shall not be iterated for brevity.

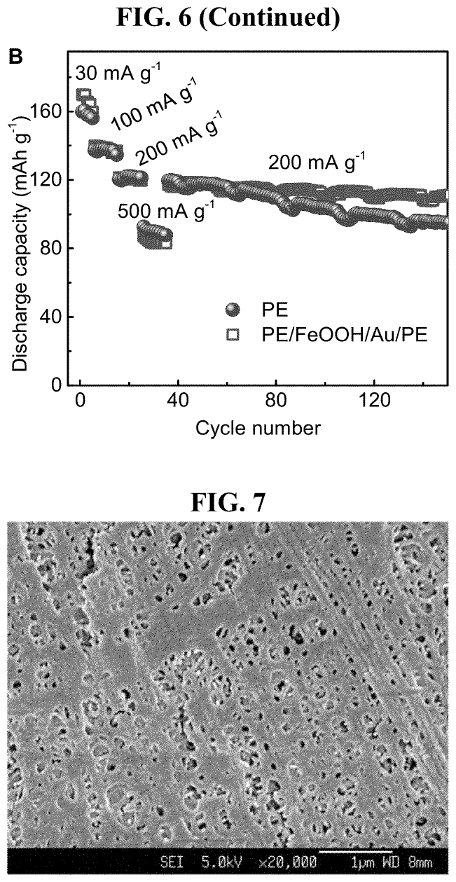

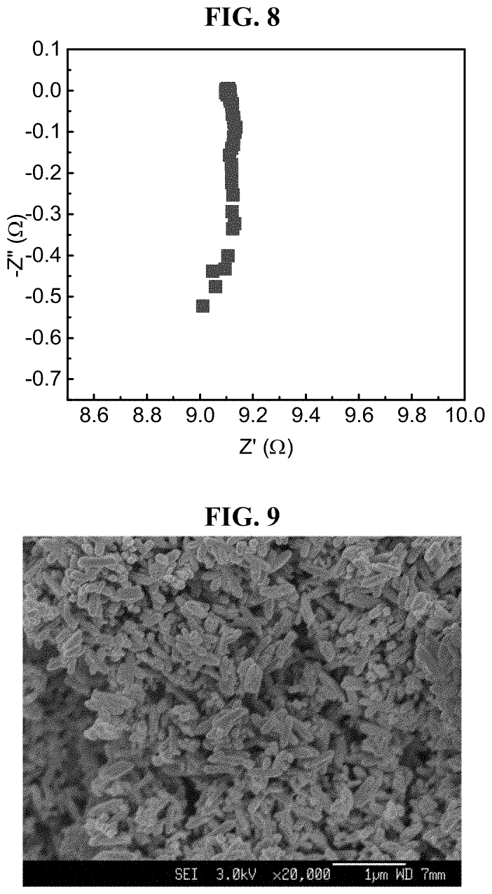

The thickness of the gold coating (Au1 and Au2) layer was controlled to be about 60 nm. A SEM image showing the porous structure of the Au coated PE can be found in FIG. 7. The Au coated PE has a sheet resistance of about 6.3 Ωsq⁻¹ (FIG. 8). Such a sheet resistance is estimated (see FIG. 4) to be sufficient for the test with an effective lithium plating area of 6 mm (i.e. the diameter of the lithium in the cell). In addition to conducting electrons, the gold coating was also used to detect the growth of lithium dendrites by monitoring the voltage between the gold layers and the copper electrodes.

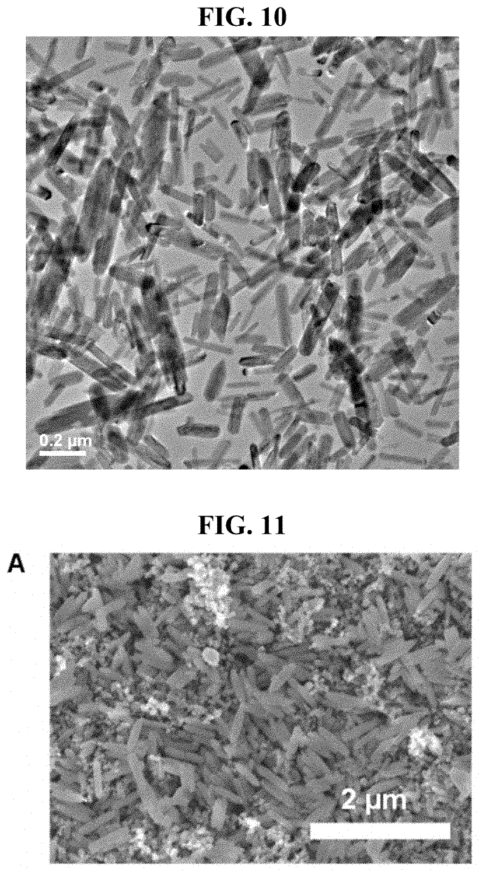

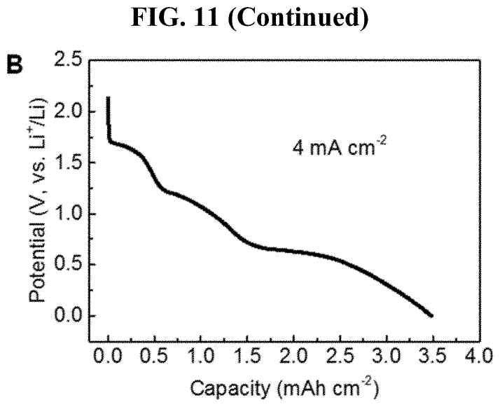

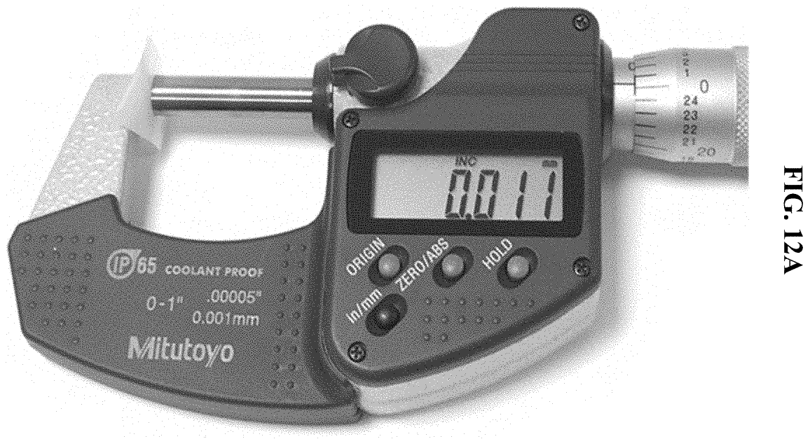

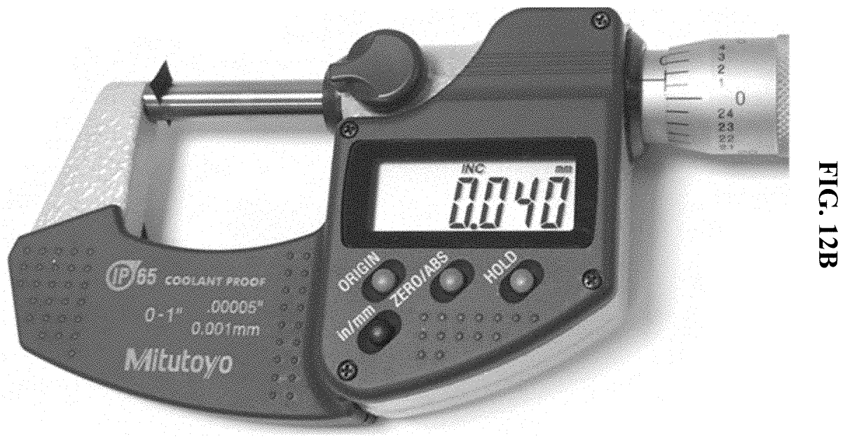

The morphology of the FeOOH and FeOOH coating layer are shown in FIGS. 9, 10 and 11A. The FeOOH has a rod-like shape. Typical thickness of the coated separator is between 37 to 44 μm. Photographs of the thickness measurements of the PE and the FeOOH coated PE are shown in FIGS. 12A and 12B, respectively. The FeOOH layer has an areal capacity of about 3.5 mAh cm⁻² at a current density of 4 mA cm⁻² (FIG. 11B).

To induce the growth of lithium dendrites, a relatively high current of 4 mA cm⁻² for lithium plating on the copper substrate is used. Details of this is already described above in example 1B and shall not be iterated for brevity. Nevertheless, when the potential of the copper electrode is higher than 0 V vs. Li⁺/Li, the lithium dendrites dissolve via oxidation and reaction on the FeOOH layer stops due to the loss of dendrite bridges.

After the dendrites penetrate the bottom PE separator layer and contact the Au1 and FeOOH layer, the lithium dendrites become unstable. This is already described above and shall not be iterated for brevity.

For comparison, the same test was performed for a cell without a FeOOH layer, and this is described in comparative example 1 above, which confirms the effectiveness of the present interlayer for suppressing growth of lithium dendrites.

In another non-limiting example and as already mentioned above, silicon is an attractive material for the interlayer for practical applications. The use of FeOOH, instead of silicon, as the active material in the experiment is specifically used to demonstrate the working of the present invention and not to limit application of the present invention to FeOOH. While a voltage drop was used to indicate the shorting of the two sides of the separators, this is difficult to observe with silicon as it has a very close potential to lithium and difficult to observe the voltage drop. This is also because the FeOOH used has a high capacity and a relatively high potential vs. Li⁺/Li (FIG. 11B), thus good for the test.

In summary, the present interlayer is an effective approach to overcome the lithium dendrite problem in rechargeable lithium batteries. The interlayer works as an anode only when there is growth of lithium dendrites and the interlayer contacts with lithium dendrites. When lithium dendrites grow and reach the interlayer, Li⁺ ions from the cathode electrochemically react with the interlayer to avoid its further reduction to form lithium and grow dendrites. Internal short circuit caused by lithium dendrites is thus avoided in LIBs with such an interlayer of a sufficient capacity. Self-immolation incidence of such rechargeable lithium batteries caused by the growth of lithium dendrites is also circumvented.

### Example 4: Commercial and Potential Applications

Since the first commercialization in 1991, lithium-ion batteries (LIBs) have become one of the power sources for cellphones and laptops due to their high energy density. With the development of large-scale applications, such as electric vehicles (EVs) and grid storage, lithium-ion battery market experiences an even faster growth. Despite the wide use, concerns over the safety of LIBs have been raised and lasted since the start of their development which was several decades ago. In fact, fire and/or explosion incidents associated with the use of LIBs were reported every year in the last decade. These incidents have led to severe safety issues and economic losses.

It is generally acknowledged that the growth of lithium dendrites, which is due to the lithium plating on the low-potential anode (e.g. graphite), is a major cause of LIB safety issues because it leads to internal short circuit. The rechargeable batteries and the interlayer disclosed herein overcome the dendrite growth problem, addressing a critical issue for LIB safety. Advantageously, large-scale applications that involve a LIB pack of hundreds or even thousands of cells having zero tolerance to the dendrite growth problem are ameliorated of such a problem. The internal short circuit of a single cell that can induce self-immolation of the whole battery pack, which is more severe than a single cell, is avoided with the present strategy.

Rechargeable batteries of the present disclosure eliminate dendritic growth and are advantageous over conventional strategies applied in LIBs, for instance, avoiding the growth of dendrites using a higher capacity of the anode than the cathode or using a high-voltage anode and chemically removing lithium dendrites. These conventional strategies may be effective only to a certain extent, as they may not completely overcome the dendrite growth problem unless the energy density is drastically sacrificed, e.g. about 40% reduction when using Li₄Ti₅O₁₂ anode instead of graphite. Dissolving dendrites by chemical reaction with an active layer has also been reported. However, this method only postpone short circuits which eventually occur. Another conventional strategy for tackling the dendrite growth problem involves detection of the dendritic growth and onset of internal short circuits, and then isolating the problematic cells. While this may improve the safety of LIBs, self-immolation incidents resulting from growth of lithium dendrites still happen.

The present approach is distinguished from conventional strategies. Instead of avoiding, dissolving, or detecting dendrites, the present approach relies on a interlayer to prevent lithium dendrites from reaching the cathode. The interlayer works as an anode only when there is growth and contact of lithium dendrites with the interlayer. The present approach stops the growth of lithium dendrites by taking Li⁺ ions from the cathode to avoid lithium plating. Using suitable materials, the interlayer does not compromise the energy density of LIBs. Thus, the present approach largely reduces self-immolation incidence of EVs, cellphones, laptops and other devices that use LIBs. Such advantages render the present approach commercially viable.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A rechargeable battery comprising:
an anode;
a cathode;
an electrolyte in contact with the anode and the cathode; and
an interlayer disposed between the anode and the cathode in the electrolyte, wherein the anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode.

2. The rechargeable battery of claim 1, wherein the interlayer is configured to comprise one or more active materials,
wherein the interlayer receives electrons from the anode for the one or more active materials comprised in the interlayer to electrochemically react with the cations when the one or more dendrites contact the interlayer, and
wherein the one or more active materials comprise Si, Sn, Al, Sb, P, graphite, amorphous carbon, SnSb, SnO, SnO₂, MnO₂, V₂O₅, TiO₂, FeO, Fe₃O₄, Fe₂O₃, FeOOH, FePO₄, NiCo₂O₄, SnS, SnS₂, Sb₂S₃, NiS, Ni₃S₂, CoS₂, CuS, FeS₂, NiP₃ or a combination thereof.

3. (canceled)

4. (canceled)

5. The rechargeable battery of claim 1, wherein the interlayer comprises an active material layer which is electronically non-conductive.

6. The rechargeable battery of claim 1, wherein the interlayer is configured to be electronically conductive.

7. The rechargeable battery of claim 1, wherein the interlayer is porous.

8. The rechargeable battery of claim 1, wherein the interlayer is non-porous.

9. The rechargeable battery of claim 1, wherein the interlayer comprises at least one electronically conductive medium, wherein the electronically conductive medium comprises copper, gold, nickel, stainless steel, conductive carbon, conductive polymer, or a combination thereof.

10. The rechargeable battery of claim 1, wherein the interlayer is electronically isolated from the anode and/or the cathode by a separator positioned between (i) the anode and the interlayer and/or (ii) the cathode and the interlayer, respectively,
wherein the separator is configurable into an ionically conductive membrane and/or the separator serves as a substrate which the interlayer is disposed on, and
wherein the separator comprises polyethylene, polypropylene, or a combination thereof.

11-13. (canceled)

14. The rechargeable battery of claim 1, wherein the interlayer is configured to comprise a binder, and wherein the binder comprises polyvinylidene fluoride, polyvinylidene fluoride-co-hexafluoropropylene, polyethylene oxide, polytetrafluoroethylene, polyurethane, polyacrylonitrile, polytetraethylene glycol diacrylate, polymethylmethacrylate, sodium carboxymethyl cellulose, or a combination thereof.

15. (canceled)

16. The rechargeable battery of claim 1, wherein the cations comprise lithium ions, and wherein the rechargeable battery is operable to have (i) the interlayer maintain a potential which is higher than a potential of Li⁺/Li when charging the rechargeable battery, and (ii) the one or more dendrites withdraw from the interlayer toward the anode when discharging the rechargeable battery.

17. (canceled)

18. (canceled)

19. An interlayer disposable between an anode and a cathode in an electrolyte of a rechargeable battery, wherein the anode is configured to allow growth of one or more dendrites in a direction from the anode to the interlayer to electronically couple the anode to the interlayer, wherein the interlayer is configured to electrochemically react with cations present in the electrolyte upon formation of the electronic coupling between the anode and the interlayer, thereby inhibiting the growth of the one or more dendrites in a direction from the interlayer to the cathode.

20. The interlayer of claim 19, wherein the interlayer is configured to comprise one or more active materials,
wherein the interlayer receives electrons from the anode for the one or more active materials comprised in the interlayer to electrochemically react with the cations when the one or more dendrites contact the interlayer, and
wherein the one or more active materials comprise Si, Sn, Al, Sb, P, graphite, amorphous carbon, SnSb, SnO, SnO₂, MnO₂, V₂O₅, TiO₂, FeO, Fe₃O₄, Fe₂O₃, FeOOH, FePO₄, NiCo₂O₄, SnS, SnS₂, Sb₂S₃, NiS, Ni₃S₂, CoS₂, CuS, FeS₂, NiP₃ or a combination thereof.

21. (canceled)

22. (canceled)

23. The interlayer of claim 19, wherein the interlayer comprises an active material layer which is electronically non-conductive.

24. The interlayer of claim 19, wherein the interlayer is configured to be electronically conductive.

25. The interlayer of claim 19, wherein the interlayer is porous.

26. The interlayer of claim 19, wherein the interlayer is non-porous.

27. The interlayer of claim 19, wherein the interlayer comprises at least one electronically conductive medium, wherein the electronically conductive medium comprises copper, gold, nickel, stainless steel, conductive carbon, conductive polymer, or a combination thereof.

28. The interlayer of claim 19, wherein the interlayer is a free-standing layer or disposed on a substrate,
wherein the substrate comprises a separator which is configurable into an ionically conductive membrane, and
wherein the separator comprises polyethylene, polypropylene, or a combination thereof.

29. (canceled)

30. (canceled)

31. The interlayer of claim 19, wherein the interlayer comprises a binder, wherein the binder comprises polyvinylidene fluoride, polyvinylidene fluoride-co-hexafluoropropylene, polyethylene oxide, polytetrafluoroethylene, polyurethane, polyacrylonitrile, polytetraethylene glycol diacrylate, polymethylmethacrylate, sodium carboxymethyl cellulose, or a combination thereof.

32. (canceled)

33. The interlayer of claim 19, wherein the cations comprise lithium ions.

34. (canceled)
